(19) United States
(12) Patent Application Publication
(10) Pub. No.: US 2023/0355029 A1
(43) Pub. Date: Nov. 9, 2023

(54) Cartridge System, Beverage Preparation Machine, and Process For Manufacturing a Cartridge System

(71) Applicant: Freezio AG, Amriswil (CH)

(72) Inventors: Marc Krüger, Bergisch Gladbach (DE); Günter Empl, Bergisch Gladbach (DE)

(21) Appl. No.: 18/025,679

(22) PCT Filed: Oct. 21, 2021
(86) PCT No.: PCT/EP2021/079271

§ 371 Date: Mar. 10, 2023

(30) Foreign Application Priority Data
Oct. 22, 2020 (DE) 10 2020 213 332.8
Oct. 22, 2020 (DE) 10 2020 213 333.6
Dec. 4, 2020 (DE) 10 2020 215 357.4
Dec. 4, 2020 (DE) 10 2020 215 361.2
Mar. 11, 2021 (DE) 10 2021 202 394.0
Mar. 11, 2021 (DE) 10 2021 202 395.9
Mar. 11, 2021 (DE) 10 2021 202 396.7

(51) Int. Cl. A47J 31/40; A47J 31/44; B67D 1/00; B67D 1/08

(52) U.S. Cl. CPC A47J 31/407; A47J 31/4492; B67D 1/0079; B67D 1/0801; B67D 2001/0812

(57) ABSTRACT

Proposed is a cartridge system for making a beverage, the cartridge system being insertable into a beverage preparation machine and comprising a cartridge that includes a reservoir filled with a beverage substance; and a cartridge receptacle; the cartridge receptacle includes a mixing chamber fluidically connectable to the reservoir, and a fluid feed line extending into the mixing chamber; characterized in that the cartridge system comprises an intermediate cap, the cartridge includes a first connection means, the intermediate cap includes a first mating connection means that is complementary to the first connection means, and the first mating connection means is connected to the first connection means.

### PRIOR ART

The present invention starts from a cartridge system for making a beverage, wherein the cartridge system can be inserted into a beverage preparation machine, wherein the cartridge system comprises a cartridge, which comprises a reservoir filled with a beverage substance, and a cartridge receptacle, wherein the cartridge receptacle has a mixing chamber, which can be brought into fluidic connection with the reservoir, and a fluid feed opening into the mixing chamber.

Such systems are known from the prior art, for example from WO 2017/121 802 A1, WO 2017/121 801 A1, WO 2017/121 801 A1, WO 2017/121 799 A1, WO 2017/121 798 A1, WO 2017/121 797 A1, WO 2017/121 796 A1 and WO 2019/002 293 A1 and are used for making beverages from pre-portioned cartridges. The production of beverages with such systems is extremely convenient for the user since he merely has to insert a cartridge and press a start button. The beverage preparation machine then undertakes the production thereof in a fully automated manner, i.e., in particular, the beverage substance is blended with a predetermined quantity of liquid, in particular cold and carbonated water, and conveyed into a drinking vessel. In this way, in particular mixed drinks can be produced much more easily, quickly and with less effort for the user. The user can choose from a large number of different cartridges here, and so he can produce different beverages as desired.

It is a challenge to store the beverage substance safely and stably in the cartridge, especially also before the use of the cartridge system in the beverage preparation machine. It is important in this context that the freshness and quality of the beverage substance is preserved. At the same time, a reliable and reproducible beverage making process should be made possible by the cartridge system.

### SUMMARY OF THE INVENTION

It is therefore an object of the present invention to provide a cartridge system which can be used in a beverage preparation machine for making a beverage and with which advantageous storage of the beverage substance and/or high-quality beverage preparation is possible, wherein the cartridge system can preferably be manufactured in a particularly cost-effective manner.

This object is achieved by a cartridge system as claimed in claim 1.

The cartridge system according to the invention has the advantage over the prior art that, with the aid of the intermediate cap, the cartridge system can be configured to be cost-effective and with advantageous leaktightness. In particular, the manufacture of the cartridge system can be improved since the intermediate cap makes possible the use of particularly inexpensive and resource-saving sealing elements for sealing the opening of the cartridge. Sealing elements of this kind preferably ensure that the beverage substance remains within the reservoir before the start of the beverage making process and is hermetically sealed there for a long shelf life and a constant aroma. Thus, according to the invention, it is advantageously possible, for example, to use particularly thin sealing elements, such as films, for sealing the cartridge. At the same time, it is nevertheless possible according to the invention to achieve a leaktight and stable connection between the sealing element and the cartridge, in particular by using the intermediate cap. It is a particular advantage that the intermediate cap can be used for positioning and fixing the sealing element, in particular before the sealing element is connected to the cartridge. Thus, the attachment of the sealing element to the cartridge can advantageously be prepared and improved with the aid of the intermediate cap. It is furthermore an advantage of the cartridge system according to the invention that the reservoir can be emptied with a comparatively high pressure during the beverage making process without unwanted leaks occurring, for example in the region where the sealing element is secured on the cartridge. This makes it possible to reduce the extraction time without any risk of impairing the taste of the beverage to be made. It is a further advantage of the present invention that the relative orientation and alignment of the cartridge and the cartridge receptacle can be defined in a particularly advantageous way by means of the intermediate cap. In this way, a definable alignment of the cartridge in the beverage preparation machine can be achieved, which is advantageous, for example, for reading out an information element, such as a QR code or a bar code, applied to the cartridge system in a state of the cartridge system inserted into the beverage preparation machine.

With the aid of the intermediate cap, the sealing element can be attached to the cartridge with high-quality leaktightness. It is thus possible to achieve sealing of the reservoir of the cartridge, which does not leak in the event of vibrations during transport or storage of the cartridge system, for example, ensuring that no gases or liquids escape from the cartridge. It is conceivable to keep liquid beverage substances with a higher carbonic acid content in the reservoir. The higher carbonic acid content can have a positive effect both on the taste of the beverage to be made and on the minimum shelf life of the cartridge. In order to maintain their freshness and quality, some beverage substances require a high internal pressure in the reservoir of the cartridge, and this is provided, in particular, by pre-carbonation. Other beverage substances require only a slight overpressure or no overpressure.

It is preferably possible for the cartridge and the cartridge receptacle to be connected to one another with the aid of the intermediate cap. It is in particular conceivable for the cartridge and the cartridge receptacle to be permanently or reversibly connected by the intermediate cap.

The cartridge preferably comprises glass. The cartridge preferably has a main body made of glass. As a preferred option it is conceivable for the entire cartridge to be produced from glass and, as a particular preference, to be designed as a glass cartridge and/or glass bottle.

Alternatively, it is conceivable to produce the cartridge completely or partially from plastic.

Alternatively, it is conceivable for the cartridge to have a main body which is produced from aluminum and which, in its typical wall region, preferably has a wall thickness of between 0.01 and 0.5 millimeters, preferably between 0.01 and 0.2 millimeters, particularly preferably between 0.03 and 0.1 millimeters and very particularly preferably substantially 0.05 millimeters, in particular with an error tolerance of at most 15%. A main body made of aluminum can be produced, for example, by deep-drawing or extrusion.

The cartridge is preferably designed in such a way that it can withstand an internal pressure of up to 12 bar, preferably up to 10 bar, particularly preferably up to 8 bar and very particularly preferably up to 6 bar, without bursting (at a temperature of 20° C. and an external pressure of 1 bar). The reservoir preferably comprises a volume of between 10 and 500 milliliters, particularly preferably between 30 and 90 milliliters and very particularly preferably substantially 60 milliliters. In particular, the cartridge system has a liquid beverage substance which preferably contains carbonic acid. It is alternatively conceivable for the liquid beverage substance not to contain carbonic acid. As a particular preference, the liquid beverage substance comprises a beverage concentrate, in particular a syrup.

It is conceivable according to the invention for the cartridge receptacle to be understood as a mixing cap of the cartridge system.

It is, in particular, conceivable for the intermediate cap to be manufactured partially or completely from glass, plastic and/or metal.

Advantageous configurations and developments of the invention can be gathered from the dependent claims, and from the description with reference to the drawings.

According to one preferred embodiment of the present invention, provision is made for the cartridge system to comprise a sealing element, wherein an opening of the cartridge is closed by the sealing element, in particular in an initial state of the cartridge system. The opening is, in particular, an opening of the main body of the cartridge, and therefore, in the initial state of the cartridge system, the main body is closed by the sealing element on its side opposite the cartridge base. The initial state of the cartridge system refers to the state before beverage preparation, although the manufacture of the cartridge system is preferably already complete in this state. The sealing element is provided for the purpose of closing the opening of the cartridge and, to this end, can be secured on the cartridge, in particular on a cartridge wall of the cartridge. The sealing element advantageously ensures that the beverage substance remains within the reservoir before the start of the beverage making process and is hermetically sealed there for a long shelf life and a constant aroma.

According to one embodiment of the present invention, it is preferably conceivable for the opening of the cartridge to be of circular design. As a preferred option, it is possible for the opening to have a diameter of between 10 and 50 mm, particularly preferably between 15 and 30 mm, more particularly preferably of at least 18 mm, for example (in particular with an error tolerance of at most 15%).

According to one preferred embodiment of the present invention, provision is made for the first mating connecting means to be connected to the first connecting means positively, nonpositively and/or materially. As a preferred option, it is conceivable for the first connecting means to be designed to run around the cartridge, in particular to run around the cartridge wall of the cartridge. As a preferred option, it is conceivable for the first connecting means to be designed to run around an outer side of the cartridge wall of the cartridge. As a preferred option, it is conceivable for the first mating connecting means to be designed to run around the entire circumference of the intermediate cap, in particular on an inner side of the intermediate cap.

According to one preferred embodiment of the present invention, provision is made for the first connecting means to comprise an external thread, wherein the first mating connecting means comprises an internal thread, wherein the cartridge and the intermediate cap are connected to one another in particular by the external thread of the cartridge and the internal thread of the intermediate cap. By virtue of the external thread and the internal thread, the intermediate cap can be screwed onto the cartridge with particularly high precision. This allows particularly advantageous positioning of the sealing element for attaching the sealing element to the cartridge. A leaktight connection between the sealing element and the cartridge can thereby be formed with particularly high reliability. The intermediate cap is preferably designed as a screw cap.

Alternatively or additionally, it is conceivable for the first connecting means to comprise one or more latching grooves and/or one or more latching beads and/or one or more undercuts for connection to the first mating connecting means, wherein the first mating connecting means preferably comprises one or more latching grooves and/or one or more latching beads and/or one or more undercuts.

According to one preferred embodiment of the present invention, provision is made for the cartridge to have a first twist prevention means and/or for the intermediate cap to have a further first twist prevention means, wherein a relative orientation between the cartridge and the intermediate cap is defined with the aid of the first twist prevention means and/or the further first twist prevention means. The first twist prevention means and/or the further first twist prevention means can thus advantageously establish a relative orientation or alignment of the cartridge and of the intermediate cap in a connected state of the cartridge and of the intermediate cap. Furthermore, the first twist prevention means and/or the further first twist prevention means can advantageously prevent unwanted release of the intermediate cap from the cartridge. In particular, the first twist prevention means and/or the further first twist prevention means are/is designed in such a way that screwing on with subsequent latching is made possible, with the result that subsequent unscrewing is prevented and/or a fixed relative orientation of the intermediate cap with respect to the cartridge can be achieved by means of the latching.

According to one preferred embodiment of the present invention, provision is made for the first twist prevention means of the cartridge to comprise an, in particular vertical, rib and/or an, in particular vertical, groove, and/or for the further first twist prevention means of the intermediate cap to comprise an, in particular vertical, rib and/or an, in particular vertical, groove. An undercut, in particular in the circumferential direction, or a spring tongue are also alternatively or additionally conceivable as the first twist prevention means and/or as the further first twist prevention means. As a particular preference, the vertical grooves and/or ribs extend parallel to an axial direction of the cartridge.

According to one preferred embodiment of the present invention, provision is made for the first twist prevention means to be designed as part of the external thread of the cartridge and/or formed adjacent to the external thread of the cartridge, and/or for the further first twist prevention means to be designed as part of the internal thread of the intermediate cap and/or formed adjacent to the internal thread of the intermediate cap. Thus, it is particularly advantageously possible for a relative position of the cartridge and the intermediate cap with respect to one another to be defined by the first twist prevention means and/or the further first twist prevention means in a state in which the intermediate cap is screwed onto the cartridge. As a result, it is possible to define both the rotational orientation between the cartridge and the intermediate cap and also a distance or spacing between a base region of the intermediate cap and an edge and/or an end face of the cartridge wall. This precise definition of the spacing between the base region of the intermediate cap and the edge and/or the end face of the cartridge wall has particular advantages for the attachment of the sealing element to the cartridge wall. For example, for the process of connecting the sealing element to the cartridge wall, it is thus possible with the aid of the intermediate cap to arrange a sealing element designed as a sealing film precisely and with a comparatively small tolerance on an end face of the cartridge wall. This precise arrangement then enables advantageous inductive welding and/or adhesive bonding of the sealing element to the end face of the cartridge wall. Conductive welding of the sealing element to the end face of the cartridge wall is also conceivable as an alternative.

According to one preferred embodiment of the present invention, provision is made for the intermediate cap to have a base region and an intermediate cap wall, wherein the intermediate cap wall extends in particular perpendicularly from the base region and circumferentially around the base region, wherein the intermediate cap is preferably of cup-shaped design. To connect the sealing element to the cartridge, it is particularly advantageously conceivable for the sealing element to be arranged in the cup shape of the intermediate cap and preferably to be secured on the intermediate cap, for example via a plastic or a wax. It is particularly preferably conceivable in this context for the sealing element to be secured on the base region of the intermediate cap. The intermediate cap can then be connected, in particular screwed, to the cartridge by means of the sealing element arranged in this way in the intermediate cap. As a result, the sealing element is arranged in such a way that it can be connected leaktightly to the cartridge wall, in particular to the end face of the cartridge wall, in particular by inductive welding or by adhesive bonding. As a particular preference, the intermediate cap remains connected, in particular screwed, to the cartridge even after the sealing element has been secured on the cartridge. After being secured on the cartridge, the sealing element is thus arranged between the cartridge wall and the base region of the intermediate cap in the axial direction.

According to one preferred embodiment of the present invention, provision is made for the base region of the intermediate cap to have a through-opening, in particular for passing a piercing spike through the through-opening of the base region. During the preparation of the beverage, the piercing spike can advantageously be guided through the through-opening of the intermediate cap and can pierce and/or perforate the sealing element. There is therefore no need for the intermediate cap to be removed from the cartridge after the sealing element has been attached to the cartridge. It is conceivable for the through-opening to form a main part of the base region of the intermediate cap, the base region thus being present only in the form of a ring around the through-opening, for example.

According to one embodiment of the present invention, it is conceivable for the through-opening of the base region of the intermediate cap to have a diameter which is greater than an outside diameter of the piercing spike.

According to one embodiment of the present invention, it is conceivable for the through-opening of the base region of the intermediate cap to have a diameter of at least 7 mm, preferably of at least 8 mm.

According to one preferred embodiment of the present invention, provision is made for the first mating connecting means to be arranged on the intermediate cap wall.

According to one preferred embodiment of the present invention, provision is made for the sealing element to be arranged between an edge of a cartridge wall of the cartridge and the base region of the intermediate cap. In particular, a peripheral edge region of the sealing element is arranged between the edge of the cartridge wall and the base region of the intermediate cap.

According to one preferred embodiment of the present invention, provision is made for the sealing element to comprise a sealing film. In particular, a peripheral edge region of the sealing film is arranged between the edge of the cartridge wall and the base region of the intermediate cap. It is possible for the sealing element to be designed completely as a sealing film or for only part of the sealing element to be designed as a sealing film. In the initial state of the cartridge system, the reservoir of the cartridge is preferably hermetically sealed by the sealing film, it being possible for the sealing film to be easily perforated by a piercing spike of the cartridge receptacle during the beverage making process in order to transfer the beverage substance from the reservoir as quickly as possible into the mixing chamber of the cartridge receptacle.

According to one preferred embodiment of the present invention, provision is made for the sealing film to comprise a plastic film, an aluminum film or a multilayer film of plastic and/or aluminum. Alternatively or in addition, it is conceivable for the sealing film to comprise a foam, a paper and/or other materials. A combination of plastic, and/or aluminum, and/or paper, and/or foam, and/or other materials is also conceivable. The design of the sealing element as a sealing film is particularly preferably possible for beverage substances which are enclosed in the reservoir without overpressure or with a comparatively low overpressure. Particularly cost-effective sealing can be achieved by means of the sealing film.

According to one preferred embodiment of the present invention, provision is made for the sealing element, in particular the sealing film, to be adhesively bonded, sealed and/or welded to the cartridge, in particular to the cartridge wall. Thus, the sealing element is secured on the cartridge wall and seals an interior of the cartridge and thus the reservoir of the cartridge. In this case, the sealing film is preferably designed to be at least substantially flat in the state in which it is mounted on the cartridge. The sealing film is preferably connected to an end face of the edge of the cartridge wall. Alternatively, it is also conceivable, for example, for the sealing element to be crimped on the cartridge wall, wherein, in particular, the sealing element comprises a crimp cap. It is conceivable for a cartridge to be able to be combined with different sealing elements and methods for mounting the sealing elements on the cartridge without a structural change in the cartridge being necessary. This increases the possible uses of the cartridge or of the cartridge system as well as scalability in a particularly cost-effective manner.

According to one preferred embodiment of the present invention, provision is made for the sealing film to be secured on the edge of the cartridge wall, in particular on an end face of the cartridge wall, by inductive welding. This permits particularly leaktight attachment of the sealing film to the cartridge, and, at the same time, it can be carried out cost-effectively. Even if there are typical irregularities on the end face of the cartridge, it is nevertheless possible, with the aid of inductive welding, to form an advantageous connection between the sealing film and the cartridge. In particular, it is conceivable for the cartridge, in particular the glass cartridge, to be formed with the aid of hot-end coating or cold-end coating. It is conceivable for the inductive welding of the sealing film to the cartridge to use a sealing lacquer which melts during inductive welding in order to form a connection between the cartridge and the sealing film. Particularly advantageous, leaktight and cost-effective sealing can thereby be achieved. As an alternative, it is conceivable for the sealing film to be secured on the end face of the cartridge wall by means of adhesive.

According to one embodiment of the present invention, it is conceivable for the sealing element to comprise a plastic cap or to be designed as a plastic cap. The plastic cap preferably comprises a bore or punching with a sealing film which is applied, sealed or welded on the inside or on the outside. According to one embodiment of the present invention, it is conceivable for the plastic cap of the sealing element to be formed with the aid of injection molding. The plastic cap is thus preferably an injection-molded part. It is conceivable here for the plastic cap to be designed as a crimp cap, latching cap or screw cap. It is conceivable for the plastic cap to have a weakening for the passage of the piercing spike. The weakening is preferably a region of the plastic cap with reduced wall thickness or thickness. The weakening is preferably designed in such a way that the piercing spike can open and/or penetrate the sealing element in the region of this weakening. It is conceivable for this weakening to be produced during the formation of the plastic cap, in particular during injection molding, as a thinned region of the plastic cap. Thus, as a particular preference, the weakening is produced during the injection molding of the plastic cap, thereby eliminating the need for any further post-processing of the plastic cap to produce the weakening. According to one embodiment of the present invention, it is conceivable for the weakening to be designed as a full-area, in particular circular-area, weakening in the plastic cap. Alternatively, other geometries are also conceivable for the weakening. It is conceivable, for example, for the weakening to be designed in the form of a ring or as a circular line.

According to one embodiment of the present invention, it is conceivable for the intermediate cap to comprise a plastic cap or to be designed as a plastic cap. According to one embodiment of the present invention, it is conceivable for the plastic cap of the intermediate cap to be formed with the aid of injection molding. The plastic cap is thus preferably an injection-molded part. It is conceivable here for the plastic cap to be designed as a crimp cap, latching cap or screw cap. It is conceivable for the plastic cap to have a through-opening, punching and/or weakening for the passage of the piercing spike. The weakening is preferably a region of the plastic cap with reduced wall thickness or thickness. The weakening is preferably designed in such a way that the piercing spike can open and/or penetrate the intermediate cap in the region of this weakening. It is conceivable for this weakening to be produced during the formation of the plastic cap, in particular during injection molding, as a thinned region of the plastic cap. Thus, as a particular preference, the weakening is produced during the injection molding of the plastic cap, thereby eliminating the need for any further post-processing of the plastic cap to produce the weakening. According to one embodiment of the present invention, it is conceivable for the weakening to be designed as a full-area, in particular circular-area, weakening in the plastic cap. Alternatively, other geometries are also conceivable for the weakening. It is conceivable, for example, for the weakening to be designed in the form of a ring or as a circular line.

According to one preferred embodiment of the present invention, provision is made for the intermediate cap to be connected to the cartridge receptacle. In particular, the intermediate cap can be inserted into the cartridge receptacle and can be connected thereto. It is conceivable for the cartridge receptacle to be connected to the intermediate cap permanently or reversibly.

According to one preferred embodiment of the present invention, provision is made for the intermediate cap to have a second connecting means, and/or for the cartridge receptacle to have a second mating connecting means, wherein the second mating connecting means is preferably connected to the second connecting means positively, nonpositively and/or materially. It is conceivable for the second mating connecting means to be a connecting means complementary to the second connecting means. Alternatively or additionally, it is conceivable for the intermediate cap to be connected to the cartridge receptacle by crimping, adhesive bonding, sealing and/or welding.

According to one preferred embodiment of the present invention, provision is made for the second connecting means to comprise one or more latching grooves, and/or one or more latching beads, and/or one or more undercuts, and/or an external thread, wherein the second mating connecting means comprises one or more latching grooves, and/or one or more latching beads, and/or one or more undercuts, and/or an internal thread. The undercut or undercuts are preferably undercuts in the circumferential direction. As a particular preference, it is conceivable, for example, for the second connecting means of the intermediate cap to comprise a latching groove, which interacts with a latching bead of the second mating connecting means of the cartridge receptacle in order to produce a latching connection. As a preferred option, it is conceivable for the second mating connecting means to be designed to run around the intermediate cap, in particular on an outer side of the intermediate cap. As a preferred option, it is conceivable for the second mating connecting means to run around the entire circumference of the cartridge receptacle, in particular on an inner side of the cartridge receptacle.

According to one preferred embodiment of the present invention, provision is made for the intermediate cap to have a second twist prevention means and/or wherein the cartridge receptacle has a further second twist prevention means, wherein a relative orientation between the intermediate cap and the cartridge receptacle is defined with the aid of the second twist prevention means and/or the further second twist prevention means. The second twist prevention means and/or the further second twist prevention means define a relative positioning and orientation between the intermediate cap and the cartridge receptacle in a connected state of the cartridge receptacle and the intermediate cap. It is furthermore advantageously possible for the second twist prevention means and/or the further second twist prevention means to prevent the cartridge receptacle and the intermediate cap from accidentally coming apart. It is particularly advantageously possible for the second connecting means to comprise the second twist prevention means and/or for the second mating connecting means to comprise the further second twist prevention means. It is particularly advantageously possible for the second connecting means to comprise a latching means, in particular a latching bead or a latching groove, which has a flattened region in the circumferential direction. It is particularly advantageously possible for the second mating connecting means to comprise a latching means, in particular a latching bead or a latching groove, which is complementary thereto and which likewise has a flattened region in the circumferential direction. With the aid of the flattened regions, a twist prevention means for the intermediate cap and the cartridge receptacle is formed.

According to one embodiment of the present invention, it is conceivable to embody the cartridge, the intermediate cap and/or the cartridge receptacle with a flattened portion or without a flattened portion. It is possible, for example, to embody the cartridge, the intermediate cap and/or the cartridge receptacle in each case on their circumference, in particular in the circumferential direction, with a flattened portion, with the result that a relative orientation of the cartridge, intermediate cap and/or cartridge receptacle is predetermined by the flattened portion. In this way, it is possible to achieve a twist prevention means, for example. Alternatively, the cartridge, the intermediate cap and/or the cartridge receptacle can also each be designed without a flattened portion in the circumferential direction, being, in particular, of round design.

According to one preferred embodiment of the present invention, provision is made for a seal to be formed between the cartridge and the intermediate cap with the aid of a sealing means. It is conceivable, in particular, for the sealing means to be arranged partially or completely between an upper side of the sealing element facing away from the cartridge and the intermediate cap, in particular a base region of the intermediate cap, such that the sealing means seals the transition between the intermediate cap and the cartridge, in particular in the region of its sealing element. In addition or as an alternative to its function as a seal, the sealing means advantageously serves to compensate for manufacturing tolerances of the cartridge, of the sealing element and/or of the intermediate cap. According to one preferred embodiment of the present invention, provision is made for the sealing means to be designed as part of the sealing element, and/or for the sealing means to be an element which is separate from the sealing element and is arranged, in particular, between the cartridge and the intermediate cap. The sealing means can thus be formed integrally with the sealing element or as a component separate from the sealing element. Various suitable materials, for example various types of rubber and/or plastics or other materials, come into consideration for the sealing means.

According to one preferred embodiment of the present invention, provision is made for the sealing means to have a sealing ring, a full-area sealing means with a bore, and/or a foam. It is conceivable for the sealing means to be designed as an insertable element. It is possible for the insertable element (for example a sealing ring) to be arranged between the cartridge, in particular that end face of the cartridge which faces in the direction of the base region of the intermediate cap, and the intermediate cap. It is conceivable, in particular, for the sealing means to be designed as an O-ring. It is alternatively conceivable for the sealing means to be designed with a bore/aperture over the entire area for the piercing spike. Alternatively, it is conceivable for the sealing means to be designed as part of the sealing element and/or connected to the sealing element, in particular on an upper side of the sealing element facing away from the cartridge. In particular, it is conceivable for the sealing means to comprise a foam (or foamed region) of the sealing element which is arranged on the upper side of the sealing element, in particular in a peripheral outer region of the sealing element.

Alternatively or in addition, it is conceivable for the sealing means, e.g. an O-ring and/or foam, to be arranged and/or formed in the region of the first connecting means and/or mating connecting means between the cartridge and the intermediate cap. Alternatively or in addition, the additional sealing between the cartridge and the intermediate cap can be accomplished, for example, by embodying the intermediate cap with the aid of a multicomponent plastic, in particular a two-component plastic.

According to one embodiment of the present invention, it is conceivable for the sealing means to be designed as part of the intermediate cap, in particular with the aid of multicomponent plastic injection molding, preferably two-component plastic injection molding. It is thus conceivable for the sealing means to be formed integrally with the intermediate cap or a part of the intermediate cap (that is to say as a component of the intermediate cap). In particular, it is possible here for the intermediate cap (or at least part of the intermediate cap) and the sealing means to be embodied jointly with the aid of two-component injection molding. It is preferably possible for the region of the sealing means to be produced from a different plastic than the remaining part of the intermediate cap. It is conceivable, for example, for the region of the sealing means to be produced from a plastic which is softer than the rest of the intermediate cap. It is conceivable in this context for the sealing means (in particular as a component of the intermediate cap) to be embodied as a region of the intermediate cap which points in the direction of the end face of the cartridge wall, in particular as a region of the intermediate cap which is adjacent to the end face of the cartridge wall and/or to the sealing element. Alternatively or additionally, it is conceivable for the sealing means (in particular as a component of the intermediate cap or as a separate insert) to be arranged laterally/radially on the cartridge wall and/or against a chamfer and/or a radius between the end face of the cartridge wall and the circumference.

According to one preferred embodiment of the present invention, provision is made for a seal to be formed between the intermediate cap and the cartridge receptacle with the aid of a further sealing means. In particular, it is conceivable for the further sealing means to be arranged partially or completely between the intermediate cap and the cartridge receptacle, with the result that the further sealing means seals the transition between the intermediate cap and the cartridge receptacle. In addition or as an alternative to its function as a seal, the further sealing means advantageously serves to compensate for manufacturing tolerances of the intermediate cap and/or of the cartridge receptacle. According to one preferred embodiment of the present invention, provision is made for the further sealing means to have a sealing ring, in particular an O-ring.

According to one preferred embodiment of the present invention, provision is made for the further sealing means to be arranged in the region of the second connecting means of the intermediate cap and/or in the region of the second mating connecting means of the cartridge receptacle. It is conceivable, in particular, for the further sealing means to be arranged partially or completely between the second connecting means and the second mating connecting means. In this case, it is possible, for example, for the second connecting means to comprise a latching groove, a latching bead, an undercut, and/or an external thread, and/or for the second mating connecting means to comprise a latching groove, a latching bead, an undercut, and/or an internal thread, wherein the connection formed between the intermediate cap and the cartridge receptacle with the aid of the second connecting means and the second mating connecting means is sealed by the further sealing means.

According to one preferred embodiment of the present invention, provision is made for the cartridge to comprise a main body, in particular of cup-shaped design, wherein the main body is formed with the aid of the cartridge wall, which is closed on one side by a cartridge base, wherein the main body comprises, in particular, the reservoir. The cartridge wall and the cartridge base are, in particular, of integral design. As a preferred option, it is conceivable for the cartridge wall to be of cylindrical design at least in a main region of the cartridge wall. The cartridge wall and the cartridge base can preferably be formed by a glass bottle. It is alternatively conceivable for the cartridge wall and the cartridge base to be formed by a plastic or a metal.

According to one preferred embodiment of the present invention, provision is made for the cartridge receptacle to have a basic structure which is produced at least partially and, in particular, completely from plastic. Low-cost production is thereby advantageously achieved.

According to one preferred embodiment of the present invention, provision is made for the basic structure to have a cup-shaped configuration, the open side of which is oriented in the direction of the cartridge, wherein a beverage outlet opening and an outwardly open spike guide are formed on a bottom side, which is situated opposite the cartridge, and wherein a fluid feed is formed on the bottom side or a side wall of the basic structure. This cartridge receptacle has the advantage that the fluid feed opens not into the reservoir of the cartridge but into the mixing chamber, which is separated from the reservoir. This prevents the beverage preparation machine from being back-contaminated by the fluid feed during the beverage making process. For this purpose, the fluid does not flow through the reservoir, but rather the beverage substance and the fluid pass separately from one another into the mixing chamber of the cartridge receptacle. The fluid is passed directly into the mixing chamber, while the beverage substance is transferred into the mixing chamber independently of the fluid. For this purpose, in particular, a displaceably mounted piercing spike is arranged within the spike guide, wherein the piercing spike is displaceable between a retracted position, in which the piercing spike is away from the sealing element and, in particular, from the sealing film and an extended position, in which the piercing spike pierces the sealing element and, in particular, the sealing film and projects into the reservoir. In the extended position, the piercing spike is guided, in particular also guided, through the through-opening in the base region of the intermediate cap. In the initial state of the cartridge system, therefore, the piercing spike is in the retracted position, with the result that the reservoir is hermetically sealed by the sealing element and, in particular, the sealing film, and can be transferred from the retracted position into the extended position in order to open the sealing element of the cartridge. In the extended position, the sealing element is perforated by the piercing spike or a pre-punching is torn open such that the beverage substance passes past the sealing element and into the mixing chamber through, in particular, at least one lateral channel on the piercing spike. Thus, easy and reliable opening of a cartridge, previously closed in an aroma-tight manner, in a beverage preparation machine is allowed. It has also been found that back-contamination of the beverage preparation machine is prevented, in particular since no overpressure acting directly on the fluid feed is generated in the reservoir. The configuration of the mixing chamber in the cartridge receptacle, which is reversibly insertable into the beverage preparation machine, advantageously ensures that the mixing chamber is part of the exchangeable cartridge system. In this way, soiling of the beverage preparation machine by the beverage substance is effectively avoided because only parts of the exchangeable disposable or reusable cartridge system come into contact with the beverage substance.

According to one preferred embodiment of the present invention, provision is made for the outer wall of the piercing spike to have at least one lateral channel for conveying the beverage substance in the direction of the mixing chamber when the sealing element has been pierced.

According to one preferred embodiment of the present invention, provision is made for the cartridge system and, in particular, the cartridge receptacle to have at least one supporting structure, which supports the sealing film in the direction of the cartridge receptacle and, in particular, in the direction of the mixing cartridge. In this way, tearing of the sealing film is prevented, particularly when pressure builds up in the reservoir during the beverage making process. The supporting structure comprises, in particular, a pillar-shaped, bridge-shaped, lattice-shaped or cylindrical structure which projects from the bottom of the mixing chamber in the direction of the reservoir and on which the sealing film optionally partially rests. It is alternatively conceivable that sealing film does not come into contact with the support structure, in particular in a variant of the present invention in which the through-opening or through-bore of the intermediate cap has a comparatively small diameter.

According to one preferred embodiment of the present invention, provision is made for the piercing spike to comprise a cylindrical or frustoconical base part and a piercing part that extends in the direction of the reservoir, wherein the piercing part is configured in the form of an obliquely truncated cone. Preferably, the piercing part is also configured such that an oblique cut face of the obliquely truncated cone substantially faces the reservoir, wherein the oval circumference of the cut face at least partially represents a cutting edge for perforating the sealing element. It has been found that the cut face which is produced by an oblique cut through the truncated cone cuts the sealing element easily and with sufficiently little force, and, moreover, does not cut off any shavings or loose bits from the sealing element, which would otherwise contaminate the beverage in an undesired manner. The sealing-element perforation is advantageously of such a form that the material of the sealing element is cut through with a smooth cut on that side of the piercing spike on which the cutting edge protruding maximally in the direction of the reservoir is formed, while, in the region of the cut face of the piercing part, the cut-off material of the sealing element is still connected to the rest of the sealing element and preferably rolls up or is folded together.

Preferably, the piercing spike comprises an intermediate part arranged between the base part and the piercing part, said intermediate part being configured in a frustoconical manner, wherein a circumferential shoulder is formed between the base part and the intermediate part, and wherein a circumferential edge is formed between the piercing part and the intermediate part. In this way, a stable piercing spike is advantageously formed. The formation of the edge has the advantage that, provided that they extend over the edge, the lateral channels have an enlarged entry on the reservoir side and thus the transfer of the beverage substance in the direction of the mixing chamber is made easier. The shoulder serves to butt against a stop of the spike guide when the piercing spike is in the extended position, such that the extending movement of the piercing spike in the direction of the cartridge is limited.

According to one preferred embodiment of the present invention, provision is made for the cartridge receptacle to have a plurality of lateral channels, wherein each lateral channel extends parallel to the piercing spike in the region of the piercing part and in the region of the intermediate part. The lateral channels are in this case each configured in particular in the form of a groove, open on one side, introduced into the outer face of the piercing spike. Preferably, the lateral channels are formed at least partially in a rear circumferential region, with respect to the cut face, of the piercing spike. This has the advantage that the lateral channels are arranged on that side of the sealing-element perforation on which a cut has been created in the material, and not on the opposite side, on which the cut-off material is still connected to the rest of the sealing element. The beverage substance can thus flow into the lateral channels in a comparatively unimpeded manner.

It is conceivable for the cross section of the lateral channels and/or the number of the lateral channels to be adapted to the viscosity of the beverage substance, such that the lateral channels control or limit the flow of the beverage substance in the direction of the mixing chamber. At a high viscosity, a plurality of lateral channels or lateral channels with a relatively large cross section are used, while, at a lower viscosity, fewer lateral channels or lateral channels with a smaller cross section are provided. Thus, a matching cartridge receptacle exists for each cartridge.

According to one preferred embodiment of the present invention, provision is made for the piercing spike to have a twist prevention means in the form of a rib protruding radially from the base part. Twisting of the piercing spike is thus advantageously avoided while it is being transferred from the retracted position into the extended position. It is also ensured that the lateral channels are arranged on that side of the piercing spike which faces away from the beverage outlet of the mixing chamber and in particular faces the fluid feed. In this way, improved mixing of the beverage substance and the fluid within the mixing chamber is achieved.

According to one preferred embodiment of the present invention, provision is made for the piercing spike to have an integrated compressed-air line, which is the cartridge emptying device, wherein the compressed-air line extends along the piercing spike, in particular from a first end of the piercing spike to a second end of the piercing spike. In this way, three functions are advantageously integrated into the piercing spike: 1. The piercing spike comprises the piercing part in order to perforate the sealing element and thus to open the cartridge; 2. The piercing spike comprises the lateral channels in order to allow the beverage substance to be transferred into the mixing chamber; 3. The piercing spike comprises the integrated compressed-air line in order to blow compressed air into the reservoir, with the result that the beverage substance is pushed into the mixing chamber under pressure.

Preferably, a compressed-air connection for connecting to a compressed-air source is formed at the second end, and a compressed-air outlet for blowing compressed air into the reservoir is formed at the first end. The cartridge emptying device integrated into the cartridge receptacle thus comprises, within the meaning of the present invention, first of all only one compressed-air line, through which compressed air can be introduced into the reservoir from the outside. The cartridge receptacle is configured such that the beverage substance is pushed out of the reservoir into the mixing chamber by the compressed air. The compressed air is provided in particular by the beverage preparation machine. It is conceivable for a compressed-air source to be coupled directly to the compressed-air connection as soon as the cartridge system is inserted into the beverage preparation machine. This has the advantage that back-contamination in the direction of the beverage preparation machine is effectively avoided because the cartridge emptying device is, in particular immediately, under pressure when the cartridge system is inserted and thus beverage substance is prevented from traveling in the direction of the compressed-air line and in particular in the direction of the compressed-air source of the beverage preparation machine. The beverage substance can thus move only in the direction of the mixing chamber from the reservoir.

According to one preferred embodiment of the present invention, provision is made for the compressed-air outlet to be configured as an opening in the cut face. This has the advantage that the air flowing into the reservoir is blown in on a side of the piercing spike that is remote from the lateral channels, such that the discharging of the beverage substance into the mixing chamber is not impeded. Preferably, a swirl thus forms in the reservoir, this favoring virtually residue-free emptying of the reservoir.

The compressed-air connection is configured in particular as an opening in the base part, wherein the base part is arranged in the cartridge receptacle such that the compressed-air connection is accessible from outside the cartridge receptacle. In this way, the connection of the compressed-air line to the compressed-air source is favored.

According to one preferred embodiment of the present invention, provision is made for the spike guide to have a guide part with an internal guide channel for receiving the piercing spike, wherein the guide channel of the guide part is configured in a substantially cylindrical or frustoconical manner, and wherein a circumferential stop is formed at an end of the guide part that faces the cartridge, said stop limiting the movement of the piercing spike in the direction of the reservoir, wherein the stop comprises in particular a region with a reduced diameter. In this way, reliable guiding of the piercing spike during the movement from the retracted position into the extended position is advantageously achieved. Preferably, a groove corresponding to the rib is formed as twist prevention means within the wall of the guide channel, such that undesired twisting of the piercing spike is prevented. The guide part is preferably arranged in the mixing chamber and protrudes from a bottom of the mixing chamber in the direction of the cartridge.

According to one preferred embodiment of the present invention, provision is made for the piercing spike to be configured as a plastic part and in particular as an injection-molded plastic part. This allows cost-effective production. In principle, however, it would also be conceivable as an alternative for the piercing spike to be formed as a metal part and/or from ceramics and/or other suitable materials.

According to one preferred embodiment of the present invention, provision is made for the piercing spike to be configured such that it is transferable from the retracted position into the extended position by a release element of the beverage preparation machine when the cartridge system is inserted into the beverage preparation machine.

According to a further preferred embodiment of the present invention, provision is made for the mixing chamber to have a beverage outlet through which the beverage formed from a blend of the beverage substance with the fluid is discharged, wherein the cartridge system is preferably configured such that the beverage is able to be introduced directly into a portable vessel from the beverage outlet. Advantageously, therefore, neither the beverage substance nor the produced beverage comes into contact with any part of the beverage preparation machine, and so any (back-)contamination of the beverage preparation machine is more or less avoided. The fluid is fed to the mixing chamber separately. Preferably, the fluid is introduced into the mixing chamber under pressure. The fluid is provided in particular by the beverage preparation machine. It is conceivable for a fluid source to be coupled directly to a corresponding fluid connection of the cartridge receptacle as soon as the cartridge system is inserted into the beverage preparation machine. The fluid connection is in this case fluidically connected to the mixing chamber via a fluid line. This has the advantage that back-contamination in the direction of the beverage preparation machine is effectively avoided because the fluid connection is, in particular immediately, under pressure when the cartridge system is inserted and thus beverage substance is prevented from traveling in the direction of the fluid line and in particular in the direction of the fluid source of the beverage preparation machine. The beverage substance and the beverage can thus move only in the direction of the beverage outlet from the mixing chamber. The fluid comprises in particular water, preferably pressurized, cooled and/or carbonated drinking water.

According to one preferred embodiment of the present invention, provision is made for the mixing chamber to be provided with mixing structures. The mixing structures advantageously ensure improved mixing of beverage substance and fluid. For this purpose, the mixing structures are configured in particular such that the fluid flowing into the mixing chamber is swirled. It is conceivable for the mixing structure to comprise one or more mixing ribs which are arranged in the region of the fluid feed at the bottom of the mixing chamber and extend substantially perpendicular to the direction in which the fluid flows in. The mixing ribs thus act as barriers for the fluid, with the result that the fluid is swirled up and better mixing with the beverage substance is achieved.

According to a further preferred embodiment of the present invention, provision is made for the fluid feed to be supplied with fluid which is cooled by a refrigeration unit, wherein the refrigeration unit is part of the beverage preparation machine or of a separate refrigerator operatively connected to the beverage preparation machine. Advantageously, it is thus possible for cold beverages to be produced even when the cartridge is not cooled and is at room temperature for example. The integration of the system into an existing refrigerator has the advantage that the existing refrigeration unit of the refrigerator can be co-used easily in an efficient manner for the beverage preparation machine. In particular, in what are known as “side-by-side” refrigerators (often also referred to as American refrigerators), sufficient installation space for integrating the system is found in the front. It is conceivable for the beverage preparation machine to be a retrofitting set for such a refrigerator. The refrigeration unit comprises preferably a compressor cooling unit, an absorber cooling unit or a thermoelectric cooler.

According to a further preferred embodiment of the present invention, provision is made for the fluid feed to be supplied with fluid to which carbonic acid is added by a carbonator. It is conceivable for the carbonator to be part of the beverage preparation machine, and wherein the carbonator has a receptacle for a CO₂ cartridge and a feeding device for adding CO₂ from the CO₂ cartridge to the fluid. Advantageously, it is thus also possible to produce carbonated soft drinks with the system. Alternatively, it would also be conceivable for the carbonator to have an external CO₂ connection.

The present invention furthermore relates to a beverage preparation machine comprising a cartridge system according to one embodiment of the present invention. The cartridge system can be inserted into the beverage preparation machine. In the inserted state of the cartridge system in the beverage preparation machine, the beverage can be prepared. After preparation has taken place, the cartridge system can be removed again from the beverage preparation machine.

The present invention furthermore relates to a process for manufacturing a cartridge system according to one embodiment of the present invention,
wherein the cartridge and the intermediate cap are provided in a first process step,
wherein, in a second process step, after the first process step, the cartridge and the intermediate cap are connected to one another by the first connecting means of the cartridge and the first mating connecting means of the intermediate cap.

According to one embodiment of the present invention, in particular of the process, it is envisaged that, in an intermediate step, before the second process step, a sealing element, in particular a sealing film, is arranged on the intermediate cap and/or is secured on the intermediate cap.

According to one embodiment of the present invention, in particular of the process, it is envisaged that the sealing element, in particular the sealing film, is secured, in particular adhesively bonded, on the intermediate cap by means of a wax and/or a plastic in the intermediate step before the second process step. It is alternatively or additionally conceivable for the sealing element, in particular the sealing film, to be secured to the intermediate cap by clamping and/or latching in the intermediate step before the second process step. The sealing element is thus preferably attached to the intermediate cap before the intermediate cap is connected to the cartridge. The sealing element is thus arranged on the intermediate cap in the second process step, as a result of which it is advantageously possible for the sealing element to be taken along when the intermediate cap is attached to the cartridge (in the second process step). Particularly advantageous positioning and/or fixing of the sealing element on the cartridge can thereby be accomplished, making it possible subsequently to connect the sealing element securely and leaktightly to the cartridge. Particularly advantageous securing of the sealing element on the cartridge is thereby possible.

According to one embodiment of the present invention, in particular of the process, provision is made for the sealing element secured on the intermediate cap to be adhesively bonded, sealed and/or welded to an edge of the cartridge wall in the second process step.

According to one embodiment of the present invention, in particular of the process, it is envisaged that,
in a first partial step of the second process step, the cartridge and the intermediate cap are connected to one another, in particular screwed to one another, by the first connecting means of the cartridge and/or the first mating connecting means of the intermediate cap,
wherein, in a second partial step of the second process step following the first partial step, the sealing element secured on the intermediate cap is connected to the cartridge, in particular to the edge of the cartridge wall, by inductive welding. In this case, the connection between the edge of the cartridge wall and the sealing element in the second partial step of the second process step is particularly preferably formed by inductive welding. Inductive welding makes possible cost-effective attachment of the sealing element with a high attachment quality, ensuring that the reservoir of the cartridge is closed and sealed by the sealing element in a particularly advantageous and stable manner. In this case, the cartridge particularly preferably comprises a glass. In particular, the sealing element comprises a sealing film or is designed as a sealing film. The arrangement and fixing of the sealing film on an end face of the edge of the cartridge wall in the first partial step of the second process step makes it possible to accomplish particularly advantageous attachment of the sealing film to the cartridge in the second partial step of the second process step. Thus, leaks during the attachment of the sealing film to the cartridge can be reduced or completely prevented by the use of the intermediate cap. Alternatively, it is also conceivable for the sealing element to be adhesively bonded to the edge of the cartridge wall in the second partial step of the second process step.

In particular, it is conceivable for the cartridge, in particular the glass cartridge, to be formed with the aid of hot-end coating or cold-end coating in or before the first process step. It is conceivable for the inductive welding in the second partial step of the second process step to use a sealing lacquer which melts during inductive welding in order to form a connection between the cartridge and the sealing element.

According to one embodiment of the present invention, in particular of the process, it is envisaged that, before the second process step, a foam layer is arranged in the intermediate cap and/or on the sealing element. As a preferred option, it is conceivable for the foam layer to comprise a synthetic foam. This makes particularly advantageous attachment of the sealing element, in particular of the sealing film, to the edge of the cartridge wall possible, in particular by inductive welding. With the aid of the foam layer, surface irregularities of the edge of the cartridge wall (or of the end face of the cartridge wall) can be compensated in a particularly advantageous manner, thus enabling a high degree of leaktightness to be reliably achieved during the attachment of the sealing element to the cartridge. It is conceivable for the foam layer to be part of the sealing element, in particular the sealing film, and therefore the foam layer does not have to be arranged separately in the intermediate cap and/or on the sealing element.

According to one embodiment of the present invention, in particular of the process, it is envisaged that, in a third process step, before, during and/or after the second process step, the intermediate cap and the cartridge receptacle are connected by a second connecting means of the intermediate cap and/or a second mating connecting means of the cartridge receptacle. It is conceivable, for example, for the second connecting means of the intermediate cap to comprise a latching groove, which is connected to a latching bead of the second mating connecting means of the cartridge receptacle in the third process step in order to produce a latching connection. In the variant in which the third process step takes place after the second process step, the cartridge already connected to the intermediate element is thus preferably connected to the cartridge receptacle via the intermediate cap.

According to one embodiment of the present invention, in particular of the process, provision is made, in an intermediate step carried out before the third process step, for the cartridge receptacle to be produced by injection molding of plastic. Advantageously, therefore, that part of the cartridge system which does not undergo high pressurization by introduction of compressed air is produced in plastic by a low-cost manufacturing process, thereby making it possible to keep the overall production costs low.

According to one embodiment of the present invention, in particular of the process, provision is made for a piercing spike to be produced in a further intermediate step, which is carried out before or after the third process step, and to be introduced into a spike guide of the cartridge receptacle.

According to one embodiment of the present invention, in particular of the process, provision is made, in a further intermediate step carried out before the second process step, for the sealing element to be punched out and/or cut out from a sealing film, preferably a plastic film, an aluminum film or a multilayer film of plastic and/or aluminum. As an alternative or in addition, it is conceivable, for example, for the sealing element to be produced with the aid of an aluminum sheet.

According to one embodiment of the present invention, in particular of the process, it is alternatively or additionally conceivable for a first connecting means, in particular a latching groove, a latching bead, an undercut and/or an external thread, to be formed on the cartridge, in particular the cartridge wall, before the second process step. According to one embodiment of the present invention, in particular of the process, it is furthermore conceivable that, before the second process step, a first mating connecting means, in particular a latching groove, a latching bead, an undercut and/or an internal thread, is produced on the intermediate cap. The intermediate cap and the cartridge are connected, in particular with the aid of the first connecting means and the first mating connecting means. In the second process step, the intermediate cap is particularly preferably screwed by means of its internal thread onto the external thread of the cartridge. Alternatively or in addition, it is conceivable for a wall of the cartridge receptacle to be crimped around the intermediate cap.

According to one embodiment of the present invention, in particular of the process, it is alternatively or additionally conceivable for a second connecting means, in particular a latching groove, a latching bead, an undercut and/or an external thread, to be formed on the intermediate cap before the third process step, in particular before the second process step. According to one embodiment of the present invention, in particular of the process, it is furthermore conceivable that, before the third process step and in particular during the injection molding of the cartridge receptacle, a second mating connecting means, in particular a latching groove, a latching bead, an undercut and/or an internal thread, is produced on the cartridge receptacle. The intermediate cap and the cartridge receptacle are connected, in particular with the aid of the second connecting means and/or the second mating connecting means. It is alternatively or additionally conceivable that a wall of the cartridge receptacle is crimped around the intermediate cap and/or that the intermediate cap wall is crimped around a wall of the cartridge receptacle.

In the first process step or before the first process step, the cartridge or at least the main body of the cartridge, which is, in particular, in the form of a cup, is preferably produced from glass. Alternatively, however, it is also conceivable for the cartridge to be produced from plastic and/or a metal, in particular aluminum. In the variant in which the main body or the cartridge is produced from aluminum, it is conceivable for the main body or the cartridge to be produced by deep drawing or extrusion. The main body is preferably of cup-shaped design with a cylindrical cartridge wall which is closed on one side by a cartridge base, the cartridge wall and the cartridge base being, in particular, of integral design. It is conceivable for the cartridge wall and the cartridge base to consist of one piece and preferably both of glass. Alternatively, it is also conceivable for the cartridge to be produced from a plurality of individual parts. It is conceivable, for example, for the cartridge wall and the cartridge base to be separate parts which are connected to one another, in particular leaktightly, for example in the first process step.

For the process according to the invention for manufacturing a cartridge system and the beverage preparation machine according to the invention, it is possible to make use of the advantages and embodiments which have already been described in connection with the cartridge system according to the invention or in connection with an embodiment of the cartridge system according to the invention. For the cartridge system according to the invention and the process according to the invention for manufacturing a cartridge system, it is possible to make use of the advantages and embodiments which have already been described in connection with the beverage preparation machine according to the invention or in connection with an embodiment of the beverage preparation machine according to the invention. For the cartridge system according to the invention and the beverage preparation machine according to the invention, it is possible to make use of the advantages and embodiments which have already been described in connection with the process according to the invention for manufacturing a cartridge system or in connection with an embodiment of the process according to the invention for manufacturing a cartridge system.

Further details, features and advantages of the invention are apparent from the drawings, and from the following description of preferred embodiments with reference to the drawings. The drawings illustrate merely exemplary embodiments of the invention which do not limit the essential concept of the invention.

### BRIEF DESCRIPTION OF THE DRAWINGS

FIG. 1 shows a schematic sectional view of part of a cartridge system according to one illustrative embodiment of the present invention.

FIG. 2 shows a schematic sectional view of an intermediate cap according to one illustrative embodiment of the present invention.

FIG. 3 shows a schematic perspective view of a mouth region of a cartridge according to one illustrative embodiment of the present invention.

FIG. 4 shows a schematic sectional view of part of a cartridge system according to one illustrative embodiment of the present invention.

FIGS. 5a, 5b, and 5c show a perspective illustration, a schematic sectional view, and the general operating principle of a cartridge system according to an illustrative first embodiment of the present invention.

FIG. 6 shows a schematic sectional view of part of a cartridge system according to one illustrative embodiment of the present invention.

FIG. 7 shows a schematic sectional view of part of a cartridge system according to one illustrative embodiment of the present invention.

FIG. 8 shows a schematic perspective view of a sectioned sealing element according to one illustrative embodiment of the present invention.

FIG. 9 shows a schematic perspective view of a sectioned intermediate cap according to one illustrative embodiment of the present invention.

### EMBODIMENTS OF THE INVENTION

In the various figures, identical parts are always provided with the same reference signs and are therefore each generally also mentioned only once.

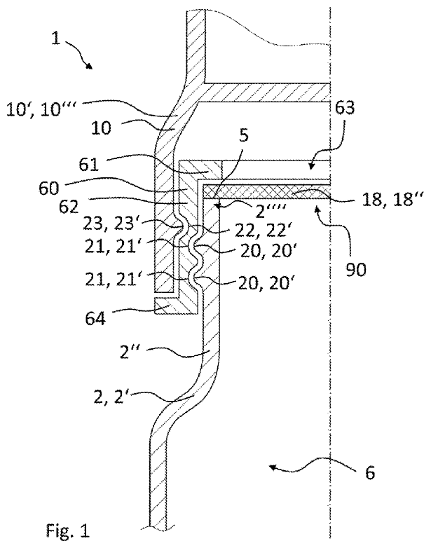

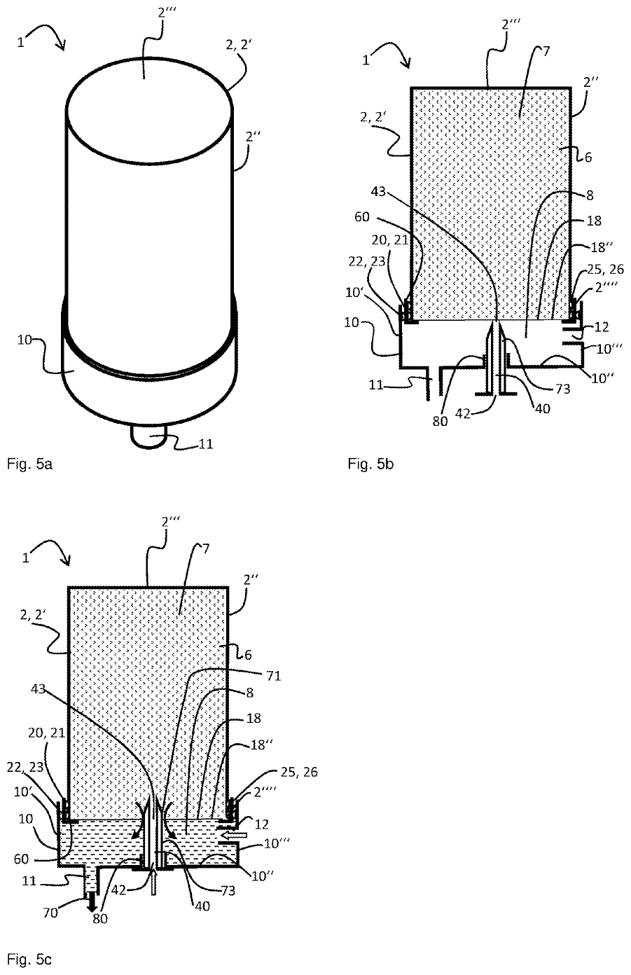

FIG. 1 illustrates a schematic sectional view of part of a cartridge system 1 according to one illustrative embodiment of the present invention. The cartridge 2 comprises a cup-shaped hollow main body 2′, with the aid of which a reservoir 6 for a beverage substance 7 is formed. Here, “of cup-shaped design” means that the main body 2′ has a cartridge base 2″′ (cf. FIG. 5b) and a cartridge wall 2″ projecting at a right angle, in particular in the direction of the cartridge receptacle 10, from the cartridge base 2″′. In this case, the cartridge wall 2″ is of at least partially cylindrical and encircling design, while the cartridge base 2″′ in this example has a circular configuration. The main body 2′ of the cartridge 2 or the cartridge 2 itself is preferably formed by or at least with the aid of a glass bottle. The reservoir 6 of the cartridge 2 can be filled with a beverage substance 7.

On a side opposite the cartridge base 2″′ in the axial direction, the cartridge 2 has an opening 90, which is closed by a sealing element 18 designed as a sealing film 18″. It is conceivable, for example, for a diameter of the opening 90 to be matched to the dimensions of a piercing spike 73. However, the opening 90 can also be larger than the piercing spike 73. The opening 90 is surrounded by an edge 2″″ of the cartridge wall 2″. An intermediate cap 60 is fitted around the cartridge 2 in this mouth region of the cartridge 2. The intermediate cap 60 comprises a base region 61 and an intermediate cap wall 62, which projects at right angles from the base region 61 of the intermediate cap 60. As a result, the intermediate cap 60 is of cup-shaped design. The intermediate cap wall 62 has a larger radius than the edge 2″″ of the cartridge wall 2″, and therefore the intermediate cap wall 62 is arranged radially on the outside around the cartridge wall 2″. The base region 61 comprises a through-opening 63 which is provided for the passage of a piercing spike 73. In this way, the piercing spike 73 can penetrate the intermediate cap 60 and thus advance as far as the sealing element 18 and perforate, pierce and/or open the latter. The cartridge 2 has a first connecting means 20 which is designed as an external thread 20′ around the cartridge wall 2″ and thus forms a threaded mouth for the cartridge 2. The intermediate cap 60 comprises a first mating connecting means 21 which is designed as an internal thread 21′. The intermediate cap 60 is screwed onto the external thread 20′ of the cartridge 2 via its internal thread 21′. One advantage of the intermediate cap 60 is that a sealing film 18″ can be attached to the cartridge 2 in a particularly advantageous manner with the aid of the intermediate cap 60. For this purpose, the sealing film 18″ is secured on the intermediate cap 60 before the intermediate cap 60 is screwed onto the cartridge 2. In particular, the sealing film 18″ is adhesively bonded to the base region 61 in the interior of the intermediate cap 60 by means of a wax and/or a plastic (and/or with the aid of some other suitable material). When the intermediate cap 60 is screwed onto the cartridge 2, the sealing film 18″ connected in this way to the intermediate cap 60 is then positioned and/or fixed above the opening 90 of the cartridge 2 and on an end face 5 of the cartridge wall 2″ at the edge 2″″ of the cartridge wall 2″. Subsequently, the sealing film 18″ is preferably connected to the end face 5 of the cartridge wall 2″ by inductive joining or welding. Alternatively, adhesive bonding of the sealing element 18 to the end face 5 is also conceivable. Thus, the reservoir 6 of the cartridge 2 is sealed by the sealing element 18.

The intermediate cap 60 is thus designed as a screw cap and particularly advantageously performs the function of fixing the sealing film 18″ on the cartridge 2, thus enabling the sealing film 18″ to be sealed inductively to the cartridge 2 after the screw cap has been screwed onto the cartridge 2. In this case, the cartridge 2 is preferably a glass bottle. However, a plastic cartridge, for example a PET (polyethylene terephthalate) bottle, can also be used as a cartridge 2.

The intermediate cap 60 connected to the cartridge 2 is furthermore connected to the cartridge receptacle 10. The connection is formed with the aid of a second connecting means 22 of the intermediate cap 60 and with the aid of a second mating connecting means 23 of the cartridge receptacle 10, which second mating connecting means is complementary to the second connecting means 60. For this purpose, the second connecting means 22 comprises a latching groove 22′, which interacts with a latching bead 23′ of the second mating connecting means 23, such that the intermediate cap 60 and the cartridge receptacle 10 are latched together. Here, the latching groove 22′ is formed on the radially outer side of the intermediate cap wall 62, and the latching bead is formed on the radially inner side of the side wall 10″′ of the basic structure 10′ of the cartridge receptacle 10. Furthermore, the intermediate cap 60 optionally comprises an edge region 64 which projects radially outward and which overlaps with the side wall 10″′ of the basic structure 10′ of the cartridge receptacle 10. The projecting edge region 64 can serve for additionally fixing the intermediate cap 60 on the cartridge receptacle 10 and/or for sealing. It is also conceivable, for example, for the edge region 64 to be formed by crimping. As an alternative or in addition to the edge region 64, many other geometries are conceivable in order to connect the cartridge receptacle 10 to the intermediate cap 60.

Furthermore, the cartridge 2 comprises a first twist prevention means 25 and/or the intermediate cap 60 comprises a further first twist prevention means 26. With the aid of the first and/or further first twist prevention means 25, 26, the relative orientation between the cartridge 2 and the intermediate cap 60—in the screwed-on state of the intermediate cap 60 on the cartridge 2—is defined. In this way, on the one hand, particularly accurate and reproducible positioning and fixing of the sealing film 18″ on the cartridge 2 for subsequent connection of the sealing film 18″ to the cartridge 2 is made possible. On the other hand, the defined orientation between the intermediate cap 60 and the cartridge 2 advantageously makes it possible for the cartridge 2 always to be inserted into the beverage preparation machine with the same orientation. It is thus possible, for example, for an information element, such as a QR code, applied to the cartridge system 1, in particular to the cartridge 2, to be advantageously read out in the state of the cartridge system 1 in which it is inserted into the beverage machine. Furthermore, with the aid of the first and/or further first twist prevention means 25, 26, the intermediate cap 60 can preferably be prevented from unintentionally becoming detached from the cartridge 2. The first twist prevention means 25 of the cartridge 2 comprises, in particular, a vertical rib and/or a vertical groove. It is conceivable for the further first twist prevention means 26 of the intermediate cap 60 to comprise a complementary vertical rib and/or a complementary vertical groove. Other first and further first twist prevention means, such as an undercut or a spring tongue, are also alternatively or additionally conceivable. A schematic example of a first twist prevention means 25 of a cartridge 2 is illustrated in FIG. 3.

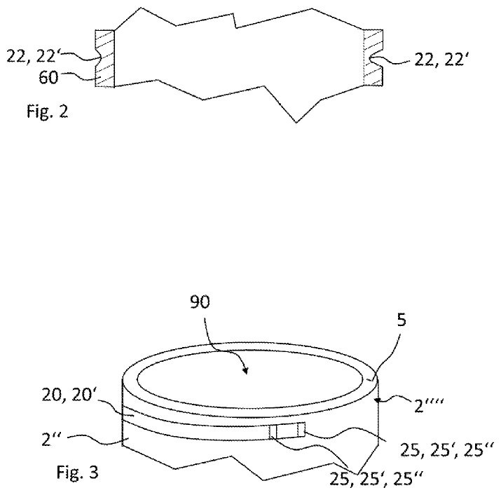

Furthermore, provision is preferably made for the intermediate cap 60 to comprise a second twist prevention means and/or for the cartridge receptacle 10 to comprise a further second twist prevention means. The second twist prevention means and/or the further second twist prevention means define/defines a relative orientation between the intermediate cap 60 and the cartridge receptacle 10 in the connected state of the intermediate cap 60 and the cartridge receptacle 10. The second twist prevention means is formed with the aid of the latching groove 22′ of the second connecting means 22, and the further second twist prevention means is formed with the aid of the latching bead 23′ of the second mating connecting means 23, as illustrated with reference to FIG. 2.

FIG. 2 illustrates a schematic sectional view of an intermediate cap 60 according to one illustrative embodiment of the present invention. In particular, the second connecting means 22 of the intermediate cap 60, which interacts with the second mating connecting means 23 of the cartridge receptacle 10, is illustrated. The second connecting means 22 comprises a latching groove 22′, which runs around the entire circumference of the intermediate cap 60. However, the radial extent of the latching groove 22′, that is to say the depth of the latching groove 22′, is preferably not constant around the circumference of the intermediate cap 60. In particular, the radial extent of the latching groove 22′ on one side of the intermediate cap 60 (right-hand side in FIG. 2) is greater than on the opposite side (left-hand side in FIG. 2). The latching groove 22′ is thus deeper on one side of the intermediate cap 60 than on the opposite side of the intermediate cap 60. As a result, the second connecting means 22 is simultaneously designed as a second twist prevention means. Owing to the varying radial extent (i.e. depth) of the latching groove 22′, there is a defined orientation for the latching groove 22′ when interacting with the latching bead 23′ of the cartridge receptacle 10. For this purpose, the latching bead 23′ too has a radial extent (not illustrated) which changes in a manner complementary to the radial extent of the latching groove 22′. The latching means 22′, 23′ thus each comprise at least one flattened region in the circumferential direction. By means of the flattened regions, a twist prevention means for the intermediate cap 60 and the cartridge receptacle 10 is formed. When the intermediate cap 60 is connected to the cartridge receptacle 10, a defined relative orientation between the intermediate cap 60 and the cartridge receptacle 10 is thus advantageously set.

FIG. 3 illustrates a schematic perspective view of a mouth region of a cartridge 2 according to one illustrative embodiment of the present invention. The cartridge 2 comprises a first connecting means 20 which is designed as an external thread 20′. The external thread 20′ has a first twist prevention means 25, which in particular comprises one or more vertical grooves 25′ and/or ribs 25″. A complementary further first twist prevention means 26, for example complementary ribs and/or grooves, is provided on the internal thread 21′ of the intermediate cap 60. When the intermediate cap 60 is connected to the cartridge 2, a defined relative orientation between the intermediate cap 60 and the cartridge 2 is thus advantageously formed. Furthermore, the first and/or further first twist prevention means 25, 26 advantageously prevent the intermediate cap 60 from unintentionally becoming unscrewed from the cartridge 2.

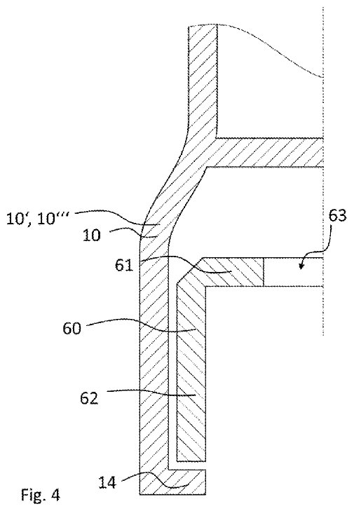

FIG. 4 illustrates a schematic sectional view of part of a cartridge system 1 according to one illustrative embodiment of the present invention. In FIG. 4, only the intermediate cap 60 and the cartridge receptacle 10 are illustrated, while the cartridge 2 is not shown. In contrast to the embodiment shown in FIG. 1, the intermediate cap 60 does not comprise an edge region 64. In contrast, the cartridge receptacle 10 comprises an edge region 14 projecting radially inward from the side wall 10″′ of the basic structure 10′. The edge region 14 extends below the intermediate cap wall 62 and has an overlap with the intermediate cap wall 62. The edge region 14 is preferably provided for fixing the intermediate cap 60 on the cartridge receptacle 10 and/or for sealing. It is also conceivable, for example, for the edge region 14 to be formed by crimping.

FIGS. 5a, 5b, and 5c show a perspective illustration, a schematic sectional view, and the general operating principle of a cartridge system 1 according to one illustrative embodiment of the present invention.

The cartridge system 1 depicted is intended for insertion into a beverage preparation machine (not illustrated) in order to prepare a beverage 70. For this purpose, the cartridge system 1 has the cartridge 2, which is filled with a beverage substance 7, and a cartridge receptacle 10, which is connected to the cartridge 2, in particular via an intermediate cap 60. Within the beverage preparation machine, a corresponding beverage 70 is made with the aid of the beverage substance 7 and an additional water source, referred to as fluid source 41 in the following text. The cartridge 2 is in this case preferably filled with a pre-portioned quantity of beverage substance 7 which is necessary for making a specific drinking portion, for example a drinking glass filling of the desired beverage 70. The beverage substance 7 is, in particular, a liquid and carbonated beverage concentrate in the form of syrup.

In principle, there is in particular a plurality of different cartridge systems 1 available, the cartridges 2 or reservoirs 6 of which are filled with different beverage substances 7 for making different beverages 70. When the user of the system 1 wishes to drink a particular beverage 70, all he needs to do is choose, from the plurality of different cartridge systems 1, that cartridge system 1 which contains the corresponding beverage substance 7 for making the desired beverage 70, insert it into a retaining unit of the beverage preparation machine and start the beverage making process at the beverage preparation machine, for example by pressing a start button, by touching a touch sensitive display in an appropriate manner, by gesture or voice control, or by means of a suitable application on a cell phone. It is also conceivable for the beverage making process to start automatically when the insertion of a new cartridge system 1 into the retaining unit is detected. In each of the abovementioned cases, the desired beverage 70 is then made automatically, conveyed into a drinking vessel and thus provided to the user. Subsequently, the used-up cartridge system 1 is removed and disposed of. The beverage preparation machine is now ready once again to be filled with any desired new cartridge system 1 in order to make a further beverage 70.

The beverage substance 7 comprises preferably liquid premixing constituents for soft drinks, such as caffeinated, carbonated, fruity and/or sugary sodas and juices, beer (mixed) drinks, or other alcoholic or nonalcoholic (mixed) drinks.

The cartridge 2 is connected, preferably screwed, to the intermediate cap 60 via a preferably encircling first connecting means 20 of the cartridge 2 and a preferably encircling first mating connecting means 21 of the intermediate cap 60. The intermediate cap 60, in turn, is connected to the cartridge receptacle 10. The cartridge receptacle 10 is connected to the cartridge 2 and/or to the intermediate cap 60, in particular after the production of the main body 2′, after the filling of the cartridge 2 with the beverage substance 7 and after and/or during and/or before the closing of the reservoir 6 by the application of the sealing element 18. The first connecting means 20 and/or the first mating connecting means 21 preferably comprise/comprises a first twist prevention means and/or a further first twist prevention means, by means of which a twist prevention device for the cartridge 2 and the intermediate cap 60 is formed. It is conceivable for the cartridge wall 2″ and the intermediate cap 60 additionally to be adhesively bonded, welded and/or pressed together.

The cartridge receptacle 10 preferably has a second mating connecting means 23, which is connected to a complementary second connecting means 22 of the intermediate cap 60. The second mating connecting means 23 and the second connecting means 22 can be, for example, complementary latching grooves and latching beads, but also, for example, threads. With the aid of the second mating connecting means 23 and/or the second connecting means 22 and/or with the aid of further elements, a twist prevention device is additionally formed for securing and defining the relative orientation between the intermediate cap 60 and the cartridge receptacle 10.

The cartridge 2 is preferably designed in such a way that it can withstand an internal pressure of up to 12 bar, preferably up to 10 bar, particularly preferably up to 8 bar and very particularly preferably up to 6 bar, without bursting (at a temperature of 20° C. and an external pressure of 1 bar). The reservoir 6 preferably comprises a volume of between 10 and 500 milliliters, particularly preferably between 30 and 90 milliliters and very particularly preferably substantially 60 milliliters.

The cartridge receptacle 10 has a mixing chamber 8 which is fluidically connected to the reservoir 6 during the beverage production process, such that, with the aid of a cartridge emptying device of the cartridge receptacle 10, the beverage substance 7 can be transferred at least partially out of the reservoir 6 into the mixing chamber 8. For this purpose, the cartridge emptying device comprises a compressed-air line 40. One end of the compressed-air line 40 is connected to a compressed-air connection 42 which can be connected to a compressed-air source of the beverage preparation machine in order to introduce compressed air into the compressed-air line 40, while the other end leads into a compressed-air outlet which is open in the direction of the reservoir 6 and introduces compressed air into the reservoir 6. The introduction of the compressed air causes the beverage substance 7 to be pushed into the mixing chamber 8. It is conceivable for the compressed-air line 40 to extend in the interior of the piercing spike 73 from the outer compressed-air connection 42, for connection to a compressed-air source, to a compressed-air outlet 43 in the region of a tip of the piercing spike.

A fluid feed 12 of the cartridge receptacle 10, which is supplied by a fluid source of the beverage preparation machine, also leads into the mixing chamber 8. It is conceivable for the fluid feed to have a quick coupling, by way of which the fluid feed 12 can be connected to the fluid source of the beverage preparation machine. The quick coupling can be configured for example such that, when the cartridge system 1 is inserted into the retaining unit, a fluidic connection is automatically established between the fluid source and the mixing chamber 8 via the fluid feed 12. During the beverage production process, fluid, in particular cooled and carbonated drinking water, passes from the fluid feed 12 into the mixing chamber 8 via this fluidic connection. Furthermore, during the beverage production process, beverage substance 7 passes from the reservoir 6 into the mixing chamber 8, as described above. As a result of the beverage substance 7 being blended with the fluid in the mixing chamber 8, the beverage 70 is formed, which then leaves the mixing chamber 8 through a beverage outlet 11.

The cartridge receptacle 10 has the beverage outlet 11, through which the beverage 70 produced within the mixing chamber 8 leaves the mixing chamber 8, and is conveyed in particular directly into the drinking vessel (not depicted), i.e. without parts of the beverage preparation machine coming into contact with the beverage 70. In this way, back-contamination of the beverage preparation machine is prevented. The drinking vessel is arranged in particular directly beneath the beverage outlet 11.

Following completion of the beverage making process, the cartridge system 1 is removed from the retaining unit, such that the beverage production machine can be fitted with a new and unused cartridge system 1. The cartridge receptacle 10 can optionally be reused by being separated from the used cartridge 2 and the intermediate cap 60 by releasing the latching connection, and being clip-fastened onto a new cartridge 2 and/or intermediate cap 60. It is conceivable for the cartridge 2 also to be reusable. In particular, it is conceivable that the cartridge 2 can be filled with a new beverage substance 7 and sealed with a sealing element 18. It is furthermore conceivable that the intermediate cap 60 can be reused, in particular in order to attach a new sealing film 18″ to a new cartridge 2 with the aid of the intermediate cap 60.

To establish the fluidic connection between the reservoir 6 and the mixing chamber 8, the cartridge receptacle 10 has a spike guide 80, in which a piercing spike 73 is displaceably mounted. The sealing element 18 is perforated by the displaceable piercing spike 73 being transferred between a retracted position, in which the piercing spike 73 is away from the sealing element 18 (cf. FIG. 5b), and an extended position, in which the piercing spike 73 pierces the sealing element 18 (cf. FIG. 5c) and projects into the reservoir 6. During the transfer from the retracted position into the extended position, the piercing spike 73 passes through the through-opening 63 of the intermediate cap 60 before the piercing spike 73 pierces the sealing element 18.

The outer wall of the piercing spike 73 is provided with the plurality of lateral channels 71 for conveying the beverage substance 7 from the reservoir 6 in the direction of the mixing chamber 8 when the sealing element 18 is pierced. The lateral channels 71 are configured in the form of grooves that are open on one side and extend parallel to one another. Following the piercing of the sealing element 18, the lateral channels 71 become fluidically connected to the reservoir 6, such that the beverage substance 7 can flow around the edges of the pierced sealing element 18 in the direction of the mixing chamber 8.

The cross section of the lateral channels 71 and/or the number of the lateral channels 71 is in this case preferably adapted to the viscosity of the beverage substance 7, such that the lateral channels 71 control or limit the flow of the beverage substance 7 in the direction of the mixing chamber 8. At a high viscosity, a plurality of lateral channels 71 and/or lateral channels 71 with a relatively large cross section are used, while, at a lower viscosity, fewer lateral channels 71 and/or lateral channels 71 with a smaller cross section are provided.

Also integrated into the piercing spike 73 is the compressed-air line 40, which acts as the cartridge emptying device. The compressed-air line 40 leads into the reservoir 6 at the end of the piercing spike 73 when the piercing spike 73 is in the extended position.

On a side of the piercing spike 73 that is in particular remote from the reservoir 6, the compressed-air connection 42 is formed, which is thus accessible from outside the cartridge receptacle 10 and is connectable to the compressed-air source of the beverage preparation machine.

Preferably, the piercing spike 73 is transferred from the retracted position into the extended position during or after the insertion of the cartridge system 10 into the beverage preparation machine or after the starting of the beverage making process, preferably by a fixed release element of the retaining unit, against which the piercing spike 73 is pushed. The piercing spike 71 is preferably configured as a plastic part and particularly preferably as an injection-molded plastic part.

It is preferably conceivable for both the fluid source and the compressed-air source to be coupled directly to the fluid feed 12 and to the compressed-air connection 42, respectively, as soon as the cartridge system 1 is inserted into the beverage preparation machine or a beverage making process is started, and in particular before the sealing element 18 is pierced. In this way, back-contamination in the direction of the beverage preparation machine is effectively avoided because the fluid feed 12 and the cartridge emptying device are under overpressure, in particular immediately upon insertion of the cartridge system 1, and this prevents the beverage substance 7 from traveling in the direction of the fluid source and compressed-air source, respectively. The beverage substance 7 can thus move only in the direction of the mixing chamber 8 from the reservoir 6 (see FIG. 5c) as soon as the sealing element 18 is opened.

The cartridge receptacle 10 comprises a basic structure 10′ with a cup-shaped configuration. The open side of this cup-shaped configuration points in the direction of the cartridge 2 and at least partially accommodates the cartridge 2 and the intermediate cap 60. On an opposite bottom side 10″, the basic structure 10′ has the beverage outlet opening 11 and the outwardly open spike guide 80. The fluid feed 12 is formed on a side wall 10″′ of the basic structure 10′. In particular, the basic structure 10′ is configured as a plastic part and particularly preferably as an injection-molded plastic part.

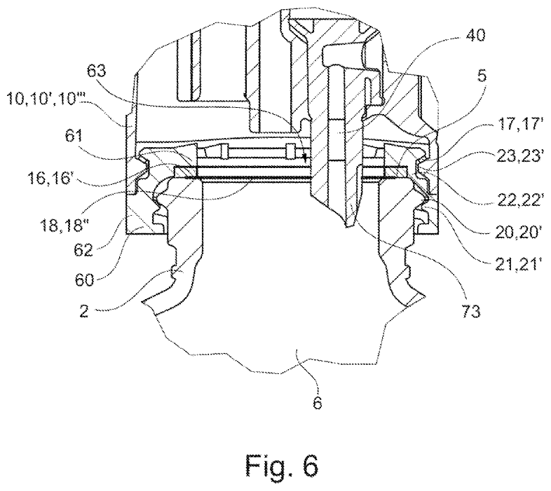

FIG. 6 illustrates a schematic sectional view of part of a cartridge system 1 according to one illustrative embodiment of the present invention. The cartridge 2 comprises a reservoir 6 for a beverage substance 7. The main body 2′ of the cartridge 2 or the cartridge 2 itself is manufactured, in particular, from or with the aid of glass. An intermediate cap 60 is attached to the cartridge 2 in the mouth region of the cartridge 2. The intermediate cap 60 comprises a base region 61 and an intermediate cap wall 62, which projects from the base region 61 and surrounds the cartridge wall in the mouth region of the cartridge 2. The base region 61 comprises a through-opening 63 which is provided for the passage of a piercing spike 73. The through-opening 63 can have different sizes and/or shapes. For example, a circular through-opening 63 or an angular or oval through-opening 63 are conceivable. It is possible for the through-opening 63 to be matched to the dimensions of the piercing spike 73 and/or to surround the latter when the piercing spike 73 is passed through. The piercing spike 73 can be passed through the through-opening 63 and in this way advance as far as the sealing element 18 and perforate, pierce and/or open the latter. In particular, the sealing element 18 is designed as a sealing film 18″. In the illustration shown in FIG. 6, the piercing spike 73 is in an extended position, in which the piercing spike 73 has pierced the sealing element 18 and projects into the reservoir 6. The cartridge 2 has a first connecting means 20 which is designed as an external thread 20′ on the cartridge wall 2″. The intermediate cap 60 comprises a first mating connecting means 21 which is designed as an internal thread 21′. The intermediate cap 60 is screwed onto the external thread 20′ of the cartridge 2 via its internal thread 21′. The intermediate cap 60 is thus designed as a screw cap. A sealing means 16 in the form of a circumferential sealing ring 16′ is formed between the base region 61 of the intermediate cap 60 and the end face 5 of the cartridge 2. The transition between the cartridge 2 and the intermediate cap 60 is sealed by the sealing ring 16′, and therefore no liquid escapes from the cartridge system 1 through this transition. Furthermore, the sealing ring 16′ advantageously serves to balance out or compensate for manufacturing tolerances of the cartridge 2 and/or of the intermediate cap 60. A further sealing means 17 is arranged between the intermediate cap 60 and the cartridge receptacle 10 and seals the transition between the intermediate cap 60 and the cartridge receptacle 10, ensuring that no liquid can escape from the cartridge system 1 through this transition between the intermediate cap 60 and the cartridge receptacle 10. Furthermore, the further sealing means 17 preferably serves as a twist prevention device (friction) between the intermediate cap 60 and the cartridge receptacle 10, in particular in the case where both the intermediate cap 60 and the cartridge receptacle 10 are designed to be rotationally symmetrical and/or have no flattened portion for twist prevention. It is furthermore optionally conceivable to form toothing between the hard components (i.e. in particular the intermediate cap and/or the cartridge receptacle) and the soft components (i.e. in particular the further sealing means 17) in order to achieve particularly advantageous protection against unwanted twisting of the intermediate cap 60 and the cartridge receptacle 10 relative to one another. The further sealing means 17 can be injection-molded as a two-component plastic injection-molded part, for example, or can be inserted manually as an additional part, and can be arranged at any desired location, in particular in the groove. In the embodiment shown, the further sealing means 17 is designed as a circumferential sealing ring 17′. The further sealing means 17 is arranged, in particular, in the region of the second connecting means 22 and of the second mating connecting means 23. The second connecting means 22 can be designed as a latching groove 22′, for example, and the second mating connecting means 23 can be designed as a latching bead 23′. Alternatively, the second connecting means 22 can be designed as a latching bead, for example, and the second mating connecting means 23 can be designed as a latching groove. The intermediate cap 60 and the cartridge receptacle 10 are fastened to one another via the second connecting means 22 and the second mating connecting means 23.

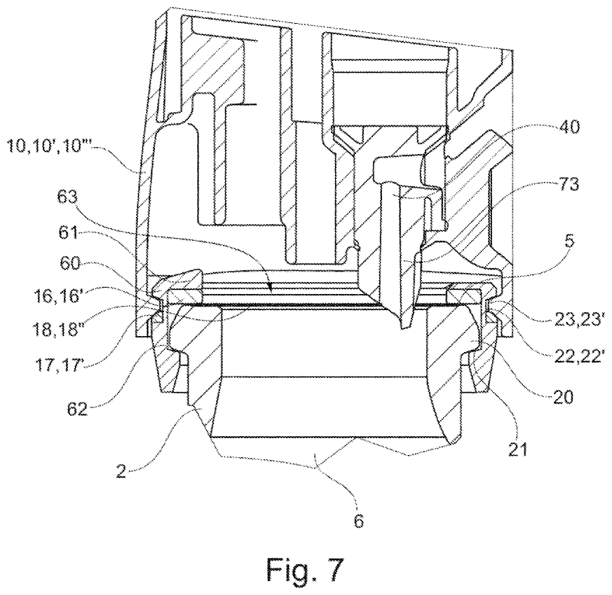

FIG. 7 illustrates a schematic sectional view of part of a cartridge system 1 according to one illustrative embodiment of the present invention. The embodiment according to FIG. 7 is similar to the embodiment illustrated in FIG. 6. The sealing element 18 is designed as a sealing film 18″ and the cartridge 2 is preferably manufactured partially or completely from glass. A sealing means 16 designed as a sealing ring 16′ is arranged between the end face 5 of the cartridge 2 and the base region 61 of the intermediate cap 60. Furthermore, a further sealing means 17 designed as a sealing ring 17′ is arranged between the second connecting means 22 and the second mating connecting means 23 in order to seal the transition between the intermediate cap 60 and the cartridge receptacle 10. The second connecting means 22 is designed as a latching groove 22′ in the intermediate cap 60, and the second mating connecting means 23 is designed as a latching bead 23′ of the cartridge receptacle 10. In contrast to the embodiment illustrated in FIG. 6, the intermediate cap 60 is latched and/or snapped onto the cartridge 2 with the aid of its first mating connecting means 21 and, in particular, is not screwed on. For this purpose, the cartridge 2 has, for example, a first connecting means 20 which is designed as a flange region on the cartridge mouth or as a latching bead. For the sealing means 16 and the further sealing means 17, the configurations, functions and advantages which have already been described in connection with FIG. 6 can be used.

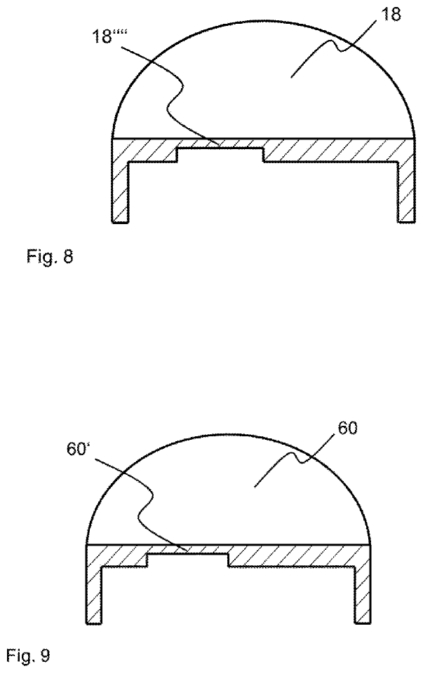

FIG. 8 shows a schematic perspective sectional view of a sealing element 18 according to one illustrative embodiment of the present invention. The sealing element 18 is designed as a plastic cap and comprises one or more plastics. The plastic cap can be formed with the aid of injection molding, for example. It is conceivable here for the plastic cap to be designed as a crimp cap, latching cap or screw cap, i.e. for it to be possible, for example, for it to be crimped, latched or screwed onto a cartridge. The sealing element 18, in particular the plastic cap, has a weakening 18″″ for the passage of the piercing spike 73. The weakening 18″″ is, in particular, a region of the plastic cap which has a reduced thickness in comparison with the adjacent regions of the plastic cap. The weakening 18″″ is preferably produced during the formation of the plastic cap, for example during injection molding, as a thinned region of the plastic cap, and therefore no further post-processing of the plastic cap is necessary to produce the weakening. The plastic cap shown in FIG. 8 can be combined as a sealing element 18 with the different embodiments of intermediate caps 60 described above, for example. The plastic cap shown in FIG. 8 can be combined as a sealing element 18 with the different embodiments of sealing means 16 and further sealing means 17 described above, for example. For example, use together with an annular or full-area sealing means 16 is conceivable, said means being designed as a separate insert or, with the aid of two-component injection molding, as part of the sealing element 18 or as part of the intermediate cap 60. For example, use together with a further sealing means 17 is conceivable, said means being designed as a separate insert or, with the aid of two-component injection molding, as part of the intermediate cap 60 or as part of the cartridge receptacle 10.

FIG. 9 shows a schematic perspective sectional view of an intermediate cap 60 according to one illustrative embodiment of the present invention. Here, the intermediate cap 60 is designed, in particular, as a plastic cap with a weakening 60′ and/or pre-punching. In this case, it is possible for the intermediate cap 60 to have no through-opening 63 in the initial state, illustrated in FIG. 9, of the intermediate cap 60. The through-opening 63 is produced by the piercing spike 73 opening the base region 61 of the intermediate cap 60 in the region of the weakening 60′. The through-opening 63 is accordingly produced by the movement of the piercing spike 73, which pierces and/or penetrates the intermediate cap 60 in the region of its weakening 60′, in particular before the piercing spike 73 opens the sealing element 18. The plastic cap shown in FIG. 9 can be combined as an intermediate cap 60 with the different embodiments of cartridge systems 1 described above, for example. The plastic cap shown in FIG. 9 can be combined as an intermediate cap 60 with the different embodiments of sealing means 16 and further sealing means 17 described above, for example. For example, use together with an annular or full-area sealing means 16 is conceivable, said means being designed as a separate insert or, with the aid of two-component injection molding, as part of the sealing element 18 or as part of the intermediate cap 60. For example, use together with a further sealing means 17 is conceivable, said means being designed as a separate insert or, with the aid of two-component injection molding, as part of the intermediate cap 60 or as part of the cartridge receptacle 10.

### LIST OF REFERENCE SIGNS

1 Cartridge system
2 Cartridge
2′ Main body
2″ Cartridge wall
2″′ Cartridge base
2″″ Edge of the cartridge wall
5 End face
6 Reservoir
7 Beverage substance
8 Mixing chamber
10 Cartridge receptacle
10′ Basic structure
10″ Bottom side
10″′ Side wall of the basic structure
11 Beverage outlet
12 Fluid feed
14 Edge region of the side wall of the basic structure
16 Sealing means
16′ Sealing ring
17 Further sealing means
17′ Sealing ring
18 Sealing element
18″ Sealing film
18″″ Weakening of the sealing element
20 First connecting means
20′ External thread
21 First mating connecting means
21′ Internal thread
22 Second connecting means
22′ Latching groove
23 Second mating connecting means
23′ Latching bead
25 First twist prevention means
25′ Groove
25″ Rib
26 Further first twist prevention means
40 Compressed-air line
42 Compressed-air connection
43 Compressed-air outlet
60 Intermediate cap
60′ Weakening of the intermediate cap
61 Base region of the intermediate cap
62 Intermediate cap wall
63 Through-opening
64 Edge region of the intermediate cap
70 Beverage
71 Lateral channel
73 Piercing spike
80 Spike guide
90 Opening

1. A cartridge system for making a beverage, wherein the cartridge system can be inserted into a beverage preparation machine, wherein the cartridge system comprises:
a. a cartridge comprising a reservoir filled with a beverage substance; and
b. a cartridge receptacle comprising:
a mixing chamber, which can be brought into fluidic connection with the reservoir; and
a fluid feed opening into the mixing chamber; and
c. an intermediate cap;
wherein the cartridge has a first connecting means;
wherein the intermediate cap has a first mating connecting means complementary to the first connecting means; and
wherein the first mating connecting means is connected to the first connecting means.

2. The cartridge system as claimed in claim 1, wherein the cartridge system comprises a sealing element, wherein an opening of the cartridge is closed by the sealing element in an initial state of the cartridge system.

3. The cartridge system as claimed in claim 1, wherein the first mating connecting means is connected to the first connecting means positively, nonpositively, and/or materially.

4. The cartridge system as claimed in claim 1, wherein the first connecting means comprises an external thread, wherein the first mating connecting means comprises an internal thread, wherein the cartridge and the intermediate cap are connected to one another by the external thread of the cartridge and the internal thread of the intermediate cap.

5. The cartridge system as claimed in claim 1, wherein the cartridge has a first twist prevention means and/or wherein the intermediate cap has a further first twist prevention means, wherein a relative orientation between the cartridge and the intermediate cap is defined with the aid of the first twist prevention means and/or the further first twist prevention means.

6. The cartridge system as claimed in claim 5, wherein the first twist prevention means of the cartridge comprises a vertical rib and/or a vertical groove, and/or wherein the further first twist prevention means of the intermediate cap comprises a vertical rib and/or a vertical groove.

7. The cartridge system as claimed in claim 5, wherein the first twist prevention means is designed as part of an external thread of the cartridge and/or formed adjacent to the external thread of the cartridge, and/or
wherein the further first twist prevention means is designed as part of an internal thread of the intermediate cap and/or formed adjacent to the internal thread of the intermediate cap.

8. The cartridge system as claimed in claim 1, wherein the intermediate cap has a base region and an intermediate cap wall, wherein the intermediate cap wall extends generally perpendicularly from the base region and circumferentially around the base region.

9. The cartridge system as claimed in claim 8, wherein the base region of the intermediate cap has a through-opening for passing a piercing spike through the through-opening of the base region.

10. The cartridge system as claimed in claim 8, wherein the first mating connecting means is arranged on the intermediate cap wall.

11. The cartridge system as claimed in claim 2, wherein the sealing element is arranged between an edge of a cartridge wall of the cartridge and a base region of the intermediate cap.

12.-28. (canceled)

29. A beverage preparation machine, comprising the cartridge system as claimed in claim 1.

30. A process for manufacturing the cartridge system as claimed in claim 1, comprising:
providing the cartridge and the intermediate cap in a first process step; and
connecting, in a second process step, after the first process step, the cartridge and the intermediate cap to one another by the first connecting means of the cartridge and the first mating connecting means of the intermediate cap.

31. The process as claimed in claim 30, in which, in an intermediate step, before the second process step, a sealing element is arranged on the intermediate cap and/or is secured on the intermediate cap.

32. The process as claimed in claim 31, wherein the sealing element is secured on the intermediate cap by a wax and/or a plastic in the intermediate step before the second process step.

33. The process as claimed in claim 31, wherein the sealing element secured on the intermediate cap is adhesively bonded, sealed, and/or welded to an edge of a cartridge wall in the second process step.

34. The process as claimed in claim 31,
wherein, in a first partial step of the second process step, the cartridge and the intermediate cap are connected to one another, in particular screwed to one another, by the first connecting means of the cartridge and/or the first mating connecting means of the intermediate cap; and
wherein, in a second partial step of the second process step following the first partial step, the sealing element secured on the intermediate cap is connected to an edge of a cartridge wall by inductive welding.

35.-38. (canceled)

39. The cartridge system as claimed in claim 8, wherein the intermediate cap is of a cup-shaped design.

40. The process as claimed in claim 31, wherein the sealing element is a sealing film.

41. The process as claimed in claim 32, wherein the sealing element is secured by adhesive bonding.
